(19) United States
(12) Patent Application Publication
(10) Pub. No.: US 2012/0066037 A1
(43) Pub. Date: Mar. 15, 2012

(54) IDENTITY NON-DISCLOSURE MULTI-CHANNEL AUTO-RESPONDER

(76) Inventor: Luke R. Glen, Penn Buckinghamshire (GB)

(21) Appl. No.: 13/321,821

(22) PCT Filed: May 20, 2010
(86) PCT No.: PCT/AU2010/000598

§ 371 Date: Nov. 22, 2011

(30) Foreign Application Priority Data
May 22, 2009 (AU) 2009902347

(51) Int. Cl. G06Q 30/02

(52) U.S. Cl. 705/14.4; 705/26.1

(57) ABSTRACT

The invention relates to allowing mobile smart-phone users to request marketing information ‘on-demand’ from businesses via a communication channel of preference without involuntary disclosure of the consumer's identity from the channel the request is made.

### FIELD OF THE INVENTION

The invention relates to allowing mobile smart-phone users to request marketing information ‘on-demand’ from businesses via a communication channel of preference.

### BACKGROUND OF THE INVENTION

Pursuing development in communication is one of the fastest growing technologies in recent times. Customer's expectations are increasing as new products and gadgets enter the market on a regular basis. Expectations include faster response times, compatibility, user friendly means of communication to request or to follow up on marketing information related to goods and services and protection of user's personal details.

There have been a number of products on the market that aim to meet customer expectations including a method to protect a user's mobile phone number.

Prior art (U.S. 2002/0072970) includes a method to protect a user's mobile phone number whilst making requests via SMS from consumer to business. The user's details are protected by having businesses register their SMS auto-responses with an independent intermediary identifying their response with a unique identifier. Consumers request that business information via the unique identifier from the intermediary and said intermediary does not forward the user's mobile phone number to the business.

Prior art (U.S. 2002/0072970 & U.S. 2003/0144016) includes a method for uniquely identifying information with an identifier that can be requested by a user across any computing device, including mobile terminal devices and PDAs.

It is common for smart-phones (mobile phone+PDA capabilities) for accessing the internet wirelessly using a combination of Telecommunication Carrier networks (GPRS, Satellite, 3G, WiMax, 2.5G, WiFi, 4G, GSM, IP, etc) and using a combination of web based technologies such as HTML, WAP, Flash, Java, etc.

There is undisputed evidence of explosive growth of alternative, social, real-time communication tools such as Social Networking sites like (Facebook, MySpace, LinkedIn, Xing, Ning, Twitter, etc) as well as Instant Messaging applications like (Skype, AOL, MSN, Yahoo, Google, iChat, Jabber, etc). These forms of real time collaboration mechanisms are considered by many as an alternative communication tool compared with the more traditional methods of Email and SMS.

With the popularity of smart-phones being constantly ‘connected’ to the Internet, there is huge access to installable local applications to ease access and interaction with Social Networking, Instant Messaging and Emailing from Mobile Phones.

In this combination of alternative forms of communication and the pervasive nature of mobile phones, prior art does not address the issue of protecting a consumer's identity across multiple communication channels whilst requesting marketing information from businesses. Prior art covers protecting ones' mobile phone number as their identity when sending an SMS. However using locally installed communication applications with constant connection to the internet means that the consumer can request marketing information from businesses from a multitude of channels from the one handset. The consumer has a different identity depending on the communication channel of choice. When using these applications, the mobile phone number is not relevant any more owing to the wide range of other communication channels now available since these channels do not use the mobile number as a unique personal identifier..

### SUMMARY OF THE INVENTION

The present invention provides a method capable of auto responding to a user requesting information via a multiple channel medium in relation to goods and services wherein said response is transmitted via the same channel medium.

Preferably, the identity of the user is kept confidential and not automatically disclosed to a third party.

Preferably, the channel is selected from any one of Email, SMS, MMS, Twitter, Instant Message, Voice Recognition, locally installed iPhone, Android, Windows Mobile or Blackberry Applications, Photo, Bluetooth, Bar Code Reader, RFID/NFC, Mobile Web Page, GPS, Facebook or other Social Networking technologies.

Preferably, a user may choose to disclose their chosen channel identity to the 3rd party.

Preferably, the identity of the provider or supplier of the goods and services is pre-registered with the system that makes the method available.

Preferably, the identity of the provider or supplier of the goods and services is displayed and/or identifiable via a unique name or number assigned to the provider/supplier.

In another aspect, the invention provides a method capable of auto responding to a user requesting information via a multiple channel medium in relation to goods and services wherein a response is transmitted via the same or different channel medium, depending on the selection nominated by the user.

In another aspect, the invention provides a computer program comprising machine-readable data obtained by auto responding to a user requesting information via a multiple channel medium in relation to goods and services wherein a response is transmitted via the same channel medium.

In another aspect, the invention provides a computer program for storing and retrieving data comprising machine-readable data obtained by auto responding to a user requesting information via .a multiple channel medium in relation to goods and services wherein a response is transmitted via the same channel medium.

In another aspect, the invention provides a computer program comprising machine-readable data obtained by auto responding to a user requesting information via a multiple channel medium in relation to goods and services wherein a response is transmitted via the same or different channel medium, depending on the selection nominated by the user.

Preferably, the response is transmitted via a different channel medium selected by the user.

Preferably, the user provides recommendations for a business and is duly rewarded.

Preferably, the user requests information in relation to goods and services provided in a preferred location, and receives a response of listing of goods and services based on the request.

Preferably, the response includes promotional material.

Preferably, the promotional material includes vouchers or file attachments such as brochures, documents, video or audio.

Preferably, the request can trigger a reminder to be sent in the response at a future date and time.

Preferably, the channel medium is selected from Twitter, Email, SMS, MMS, Instant Message, Voice Recognition, locally installed iPhone, Android, Windows Mobile or Blackberry Applications, Photo, Bluetooth, Bar Code Reader, 2D Barcodes, GPS and Social Networks such as Facebook, LinkedIn, Ning, Xing, MySpace.

### BRIEF DESCRIPTION OF THE DRAWINGS

FIG. 1—Overview of the Platform Architecture highlighting the 4 main areas: Multi-Channel Consumer Interaction; Social Network Integration; 3rd Party Developer API, Support Infrastructure Integration

FIGS. 2a and 2b—Multi-Channel Interaction Methods and Implementation

FIG. 3—Identity Protection and Disclosure Process

### DETAILED DESCRIPTION OF THE INVENTION

The present invention provides the ability to protect a consumer's identity regardless of the communication channel they choose to request marketing information from a business. The present invention protects a consumer's Email Address(s), Social Networking IDs, Instant Messaging IDs as well as their mobile phone number(s). Since consumers use the same identities on their traditional PCs connected to the Internet, the present invention covers access from these devices as well as smart mobile phones.

The present invention also allows the consumer to control when and if to disclose their chosen identity to a business they request information from.

The present invention also tracks the information received from a business, with their requesters' friends/contacts in Social Networking environments. The present invention tracks the recommendation, and the ‘click-through’ count from the referee to that business because of the referrer's recommendation, and in return rewards the referrer for their recommendation. This is achieved by generating a unique URL for each response which in turn directs the user to the desired location. Since each response URL is unique, click-throughs can be measured accurately and identified with a known user of the system.

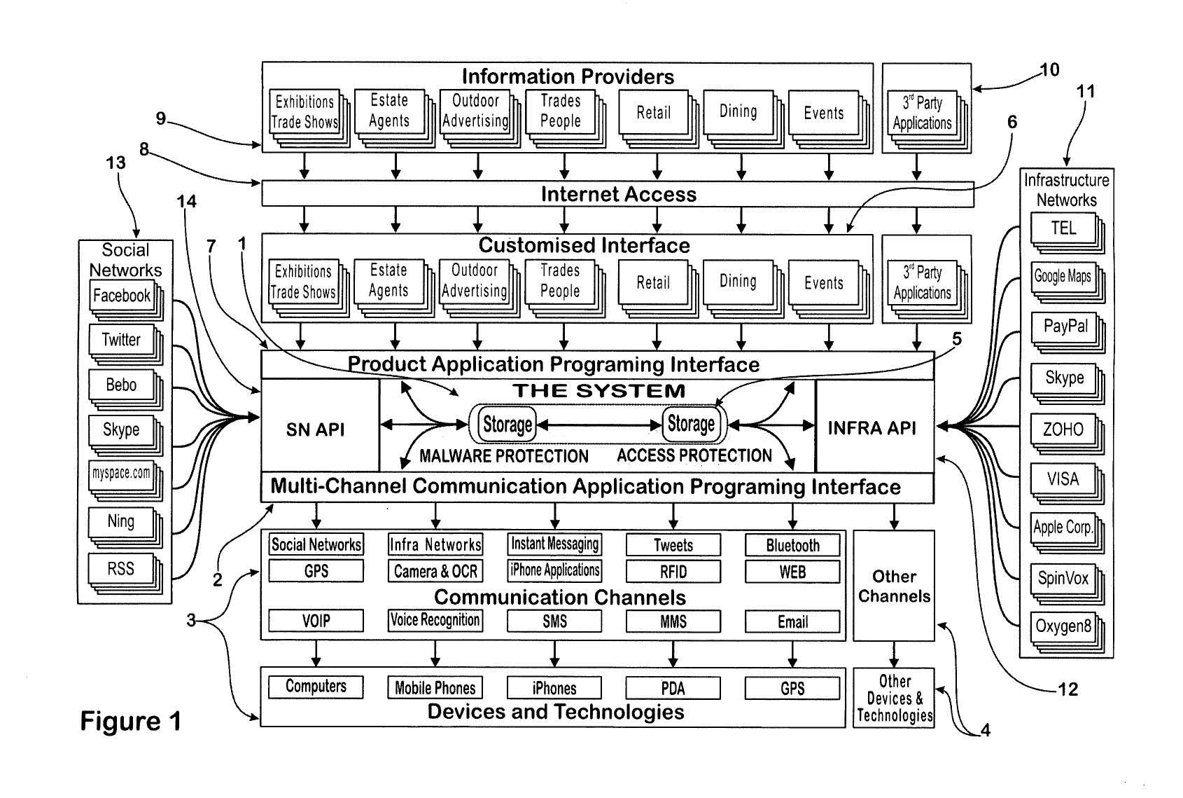

In one embodiment of the invention, as shown in FIG. 1, the System (1) is a Multi-Channel Auto-Responding Platform that protects the multiple identities of a requester across requests from multiple channels (3) whilst responding to them with pre-defined, pre-registered information from business owners (9) stored at (5) and identified via a unique identifier.

The System (1) offers a Multi-Channel Communication API (2) that allows multiple communication channels, devices and technologies (3) to interact with the System in a non-format dependant mode. The API (2) provides for 3rd party alternate consumer devices, channels (4) and technologies to interact with the System (1).

Information providers (9) through a customised interface (6) specific for their needs, provide information, identified with a unique identifier, submitted over the internet or wireless network (8) and stored in a repository (5) within the System (1) awaiting request from Consumer devices (3).

The Product API (7) allows development of 3rd party applications to interact with and submit information from providers (9) to the repository (5) in the System (1).

Through the Infrastructure API (12), the System can integrate with and leverage external infrastructure services (11) such as Geo-Mapping, Voice Recognition, Voice over IP, and Proprietary Push/Notification Engines such as Apple and RIM.

Requesters can easily share Identifiers or the Information received from the System (1) in relation to an identifier, with their personal contacts in various Social Networks (13), made possible via a Social Network API (14). This API (14) allows the System's users to access their Identifiers and the associated information from within the supported Social Network (13). The API (14) allows 3rd party developers to support integration to multiple Social Networking Applications.

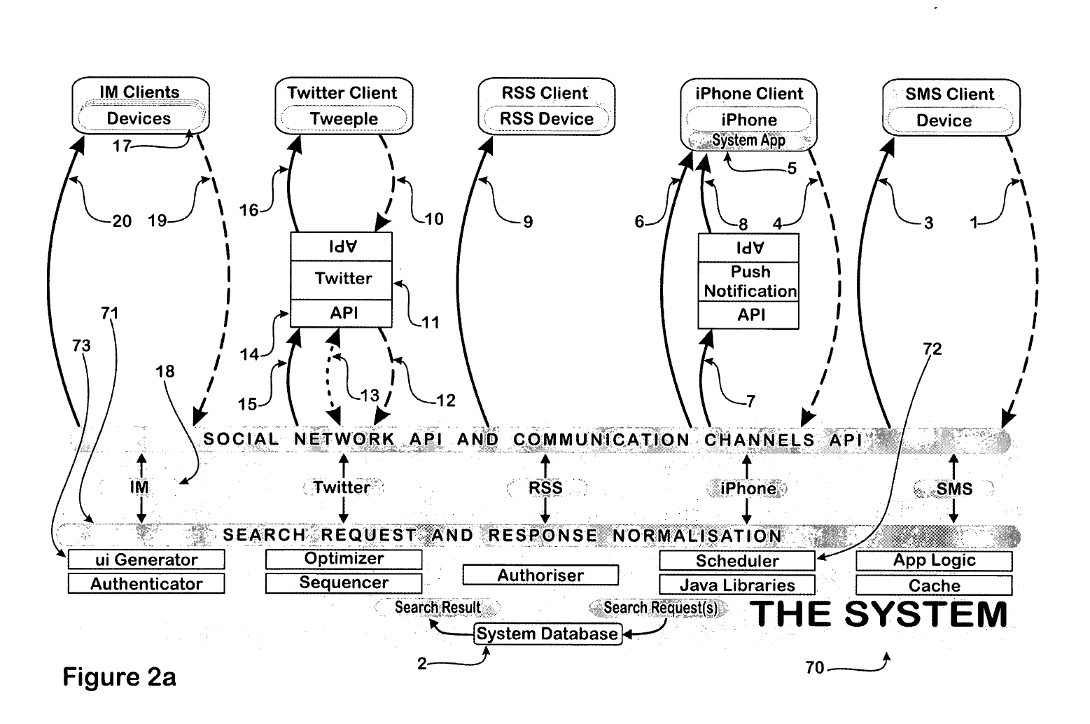

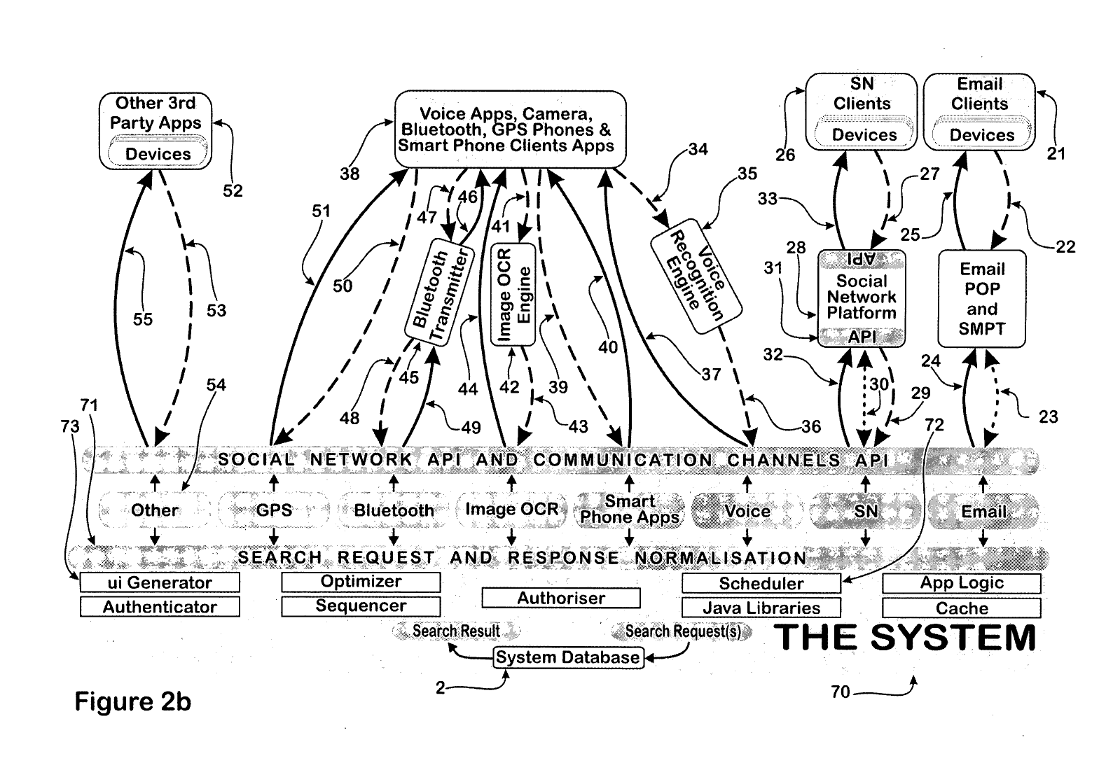

In another embodiment, as shown in FIGS. 2a and 2b, consumers can request pre-defined information from businesses by sending an Identifier to the system (70) from any one of a variety of channels. Requests from any channel are normalised to make them channel independent (71), so the system can process all requests as if they were the same. Identifiers are unique per country region. When businesses nominate and register a unique identifier, they will locate with the use of an integrated mapping technology the location of that business which the Identifier is associated. The system will translate the geo-code into country location and check that the nominated identifier is unique within the country. This step is necessary since the System is globally capable of processing inbound user requests from any channel from any country for Identifiers associated with a specific country.

Each valid Identifier is stored (2) with its associated geo-tag and country code for correlating inbound user requests by country.

In each of the methods below, once the appropriate Identifier for the relevant country is located, the associated response is returned to the user on the same channel unless the user has their account settings to respond on an alternative channel. Responses are also stored online (2). Unless users choose an alternative response channel, all future updates are sent on the same originating inbound channel too; otherwise the nominated response channel is used. Any updates to Identifier Responses are broadcast to subscribing users on their channel of choice. Broadcasts are scheduled (72) and the appropriate transcoding/formatting for the destination channel applied (73).
SMS—User sends the Identifier (1) to a published/displayed shortcode or mobile number owned by the System. Shortcodes in their accessibility are unique by country. Shortcodes are not accessible by mobile phone users from outside that country. In addition, there is no country identifying information in a shortcode. The System already stores (2) the country associated with each Shortcode. The appropriate Identifier is located and its associated Response is returned (3).
iPhone—Users invoke a request (4) from their locally installed custom application (5) that uses a data network connection rather than the tradition GSM connection that SMS & Voice channels use. Users will have already nominated their current country settings (5) so the System (70) knows which country the request for an Identifier is coming from. Responses are sent back to the local application (6). Future Identifier Response updates are scheduled (72) and pushed to Apple (7) where their notification engine pushes updates to iPhone handsets with response update notifications (8).
RSS Clients—Users don't make Identifier requests from this client. Any and all Updates from Identifiers that the user has subscribed to via any of the other channels are pushed through this RSS channel (9).
Twitter—For existing users that have chosen to follow The System (70), they can request an Identifier by submitting a Direct Message (10) to the Twitter platform (11). System (70) polls the Twitter platform (11) at regular and frequent intervals to retrieve new Requests (12) with the ‘Identifier’ as the tweet message(s) content. System users will have registered in their profile, their default country (2). The System extracts the Tweet (13) using the Twitter API (14), identifies the user based on their Twitter ID, identifies their default country and locates the Response that is associated with that country Identifier. The Response is returned (15) to Twitter as a Direct Message. Twitter forwards the Response to the user as a Direct Message (16). Should a user wish to request an identifier from another country, they can append an Internet domain suffix to the Identifier such as ‘Identifier.uk’ or ‘Identifier.us’. In this instance, the System will recognise the suffix and locate the relevant Identifier, ignoring the Twitter Users' default country setting in the System User Profile. Responses are always returned via private Direct Message (15, 16).
Instant Messaging (Skype, AOL, MSN, gTalk, Yahoo, Jabber, iChat)—Existing System Users add System to their IM client as a Contact (17). System uses the IM APIs (18) to accept the invitation and adds the User to the System Ns Contact List (2). User initiates a text chat session with System and sends only ‘Identifier’ as the message (19). System extracts the message, the User Identity and Identifier using the IM APIs (18) and locates the appropriate Identifier Response (2) based on the IM Users default country setting in their user profile (2). Should a user wish to request an identifier from another country, they can append an Internet domain suffix to the Identifier such as ‘Identifier.uk’ or ‘Identifier.us’ In this instance, the System will recognise the suffix and locate the relevant Identifier, ignoring the IM Users' default country setting in the System User Profile. A Response is returned (20).
FIG. 2b
Email—Users include the Identifier in the subject field (21). The System will ignore any body content. The user addresses and sends (22) the email to a common global email address owned by System (70). The System extracts the email from the receiving POPS server (23) using JavaMail API, identifies the user based on their ‘From Email Address’, identifies their default country and locates the Response (2) that is associated with that country Identifier. System users will have registered in their profile (2), their default country. The Response is returned (24, 25). Should a user wish to request an identifier from another country, they can append an Internet domain suffix to the Identifier such as ‘Identifier.uk’ or ‘Identifier.us’. In this instance, the System will recognise the suffix and locate the relevant Identifier, ignoring the Email Uses' default country setting in the System User Profile (2).
Facebook, MySpace and other Social Networks (SN)—SN Users request System to join as a Friend (26). User initiates a Friend Chat (27) with System via the Social Network (28) and sends only ‘Identifier’ or sends a message to the System's Inbox on that SN for those SNs that support this feature. System polls the SN on a regular and frequent interval to retrieve any Request(s) that have been made (29). System extracts the message(s) (30), the User Identity and Identifier using the SN APIs (31) and locates the appropriate Identifier Response (2) based on the SN Users default country setting in their user profile (2). Should a user wish to request an identifier from another country, they can append an Internet domain suffix to the Identifier such as ‘Identifier.uk’ or ‘Identifier.us’. In this instance, the System will recognise the suffix and locate the relevant Identifier, ignoring the SN Users' default country setting in the System User Profile (2). A Response is returned (32) to the ‘Friend’ to the Social Network (28). The Social Network then notifies the User with the Response (33).
Voice—User makes a phone call (34) to a published country specific number, owned by System (70), where a Voice Recognition Engine (35) will translate the spoken ‘Identifier’ and pass the textual equivalent (36) to the System. The System will locate the appropriate Identifier (2) and Return its associated Response as an SMS to the mobile phone (37) the call was initiated from, unless the User has nominated an alternate response channel.
Smart Phone Application users (38) (currently Blackberry, Android, iPhone, Java or Windows Mobile). Users invoke a request (39) from their locally installed custom application that uses a data network connection rather than the tradition GSM connection that SMS & Voice channels use. These requests will be identified to a specific known user because their identity is stored (38) and transmitted with the request (39). Users will have already nominated their current country settings (2) so the System knows which country the request for an Identifier is coming from. Responses are sent back to the local application (40). Future Identifier Response updates are scheduled (72) and pushed directly back to those applications (40), should those platforms support Push Notification.
Image OCR—User uses the pre-installed System software application (38) on their camera enabled smart phone to take a photo of the ‘Identifier’. The software sends the image to the System (41). An Optical Character Recognition System (42) receives the image request and extracts the Identifier as Text and forwards it (43) to the System (70). The Identifier is located (2) based on the GPS Geo-coded co-ordinates sent with the Image (41, 43). The request will be identified to a specific known user because their identity is stored (38) and transmitted with the request (41,43). The appropriate Response is returned via an SMS (44) using the mobile phone number sent with the Image or on an alternate channel previously nominated.
Bluetooth—Bluetooth enabled smart phones/PDAs (38) are detected by the Bluetooth transmitter (45). The user is offered the Identifier (46). If the user accepts (47), the transmitter transmits the response to the handset (46). The handset identifier is passed (48) to the System so the request and response can stored online (2). If the user already subscribes to the Identifier, the Bluetooth transmitter can assume permission to send the response directly to the handset when handset is detected and identified (46). The System schedules (72) updates the Bluetooth transmitter periodically as Responses are updated (49).
GPS/LBS—Users of GPS (real-time location aware) enabled Smart Phones (38) can make a request to System with ‘Identifier’, along with supporting GPS coordinates automatically (50) that will allow the System to identify their location (2) at the time of request. A response is located (2) and returned (51).
Other Third Party Applications—Third Party Developers can develop an application on Smart Phones (38, 52) or Wireless Computing Devices (52) and use the generic System APIs (54) to make a request with an Identifier. System will locate the associated response (2) and return it (55) to that Third Party Application.

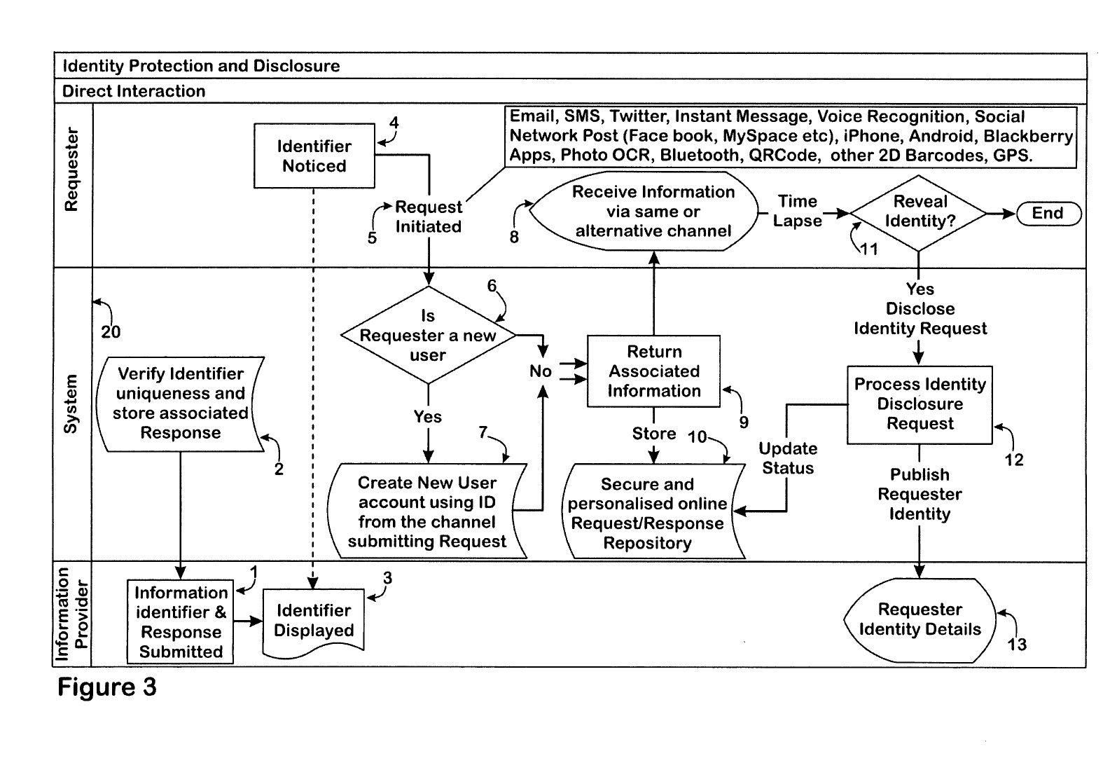

In another embodiment, as shown in FIG. 3, the business owner submits, for example, via a website, an identifying code (1) that identifies a business entity, product or service. A response associated with that identifier is submitted at the same time. The response provided is absent of channel dependent formatting.

The requested identifying code is checked (2) against a repository of known identifiers and only accepted if it is unique for the preferred country. The associated response is stored with the unique identifier.

The new unique identifier is advertised, displayed, communicated with users (3) in any medium of preference including Print, Digital, Audio and/or Video.

When a user (4) is interested in obtaining information related to an identifier, they choose one of their preferred supported channels to initiate a request that includes only the identifier (5).

SMS—Text ‘Identifier’ to a published shortcode or mobile number owned by the

System (20). (Mobile Number is transmitted with request as Requesters' Identity)
Email—Email ‘Identifier’ in the subject field to a published email address owned by the System (20). (Email Address is transmitted with request as Requesters' Identity)
Twitter—For users that follow the System (20), send a Direct Message to the System with the ‘Identifier’. (Twitter username is transmitted with request as Requesters' Identity)
Facebook and other Social Networks—For users that have the System (20) as a Friend, initiate a Friend Chat with System and send only ‘Identifier’ (Social Network username is transmitted with request as Requesters' Identity).
Instant Messaging (Skype, AOL, MSN, gTalk, Yahoo, Jabber, iChat)—For users that have System (20) as a contact in their contacts list, initiate a text chat session with only ‘Identifier’ (IM Tool & username is transmitted with request as Requesters' Identity).
Voice—Make a phone call to a published number, owned by System (20), where a Voice Recognition engine will recognise the spoken ‘Identifier’ and pass the textual equivalent to the System (Mobile Phone Number is transmitted with request as Requesters' Identity)
Smart Phone Application users (iPhone, RIM, Android, Windows, Java) to make a direct request using ‘Identifier’. Applications supplied by System (20). (Client Application's username is transmitted with request as Requesters' Identity).
Image OCR—User uses the pre-installed software application on their camera enabled smart phone to take a photo of the ‘Identifier’. The software sends the image for Optical Character Recognition to the System (20). (Mobile Phone Number or System username is transmitted with request as Requesters' Identity)
Bluetooth—Bluetooth enabled smart phones/PDAs request the Identifier received from the Bluetooth transmitter to either the System (20), or back to the Bluetooth transmitter to receive the response. (Mobile Phone Number is transmitted with request as Requesters' Identity).
GPS/LBS—Users of GPS (real-time location aware) enabled Smart Phones can make a request to System (20) with ‘Identifier’, along with supporting GPS coordinates automatically that will allow the System to identify their location at the time of request. (Mobile Phone Number or System username is transmitted with request as Requesters' Identity)

The System attempts to authenticate (6) the identity of the requester for the inbound request (5). If the user is known, the associated response for the identifier is obtained from the repository (9), formatted for the necessary outbound channel (9) and returned to the requester. Typically, the outbound channel is same as the inbound channel, but does not have to be if the requester has already instructed the

System previously to use an alternate outbound channel (9).

If the System cannot authenticate the identity of the requester (6), the System uses the Identity that is associated with the inbound request to create a new user (7) in the System to be known by that Identity. Users can update their profile in the System to include a combination of other Identities for use with other channels for future requests. Once the new user account is created, the response is then retrieved, formatted and returned to the requester (9).

All inbound requests regardless of channel are aggregated and made available to the requester for future access via an online repository (10). This repository can be accessed visually via the System's web application interface, by request/search from one of the requester's desired channels or via the Systems APIs for 3rd party applications to access.

At any time, the requester can use the System to disclose/reveal their chosen identity with the owner of a specific Identifier (11). This can be done via the System's online web application interface or by sending a command ‘RevealID Identifier’ via their preferred channel (11).
On disclosure request, the System will make the requester's chosen Identity available/visible to the owner of the identifier (12). Any alternate identities that the requester has in their profile remain confidential. The Identifier owner is able to access/view the requester's chosen identity (13).
Users of GPS or Location Aware Phones, can request marketing on-demand by sending a request to System with the category of Identifiers desired along with the distance desired. For example, at lunch time, a user can send a request to System for any Identifiers of type ‘Restaurant/Cafe’ within 2 kms of their current location. System will return to the user any on-demand responses (offers) from their preferred (subscribed) Identifiers only, in real-time so that the user can review the offers and choose where the user wish to dine for lunch. User does not get a listing of all restaurants/cafes in the area, just from their preferred list of Identifiers. The request/response will use the same channel. If any of those on-demand offers are defined vouchers, then the user and vendor/merchant can validate the voucher at time of service/product consumption. System will track & measure the end-to-end on-demand marketing campaign/activity based on this method.

Similarly, the system according to the present invention may be used by other vendors of goods and services such as estate agents, retail shops, advertisers, live event promoters and the like.

For example, the present invention enables a prospective home buyer to make enquiries about a property listing through the real estate agent via SMS, Email, Instant Messengers, Camera, Mobile Web browser or Twitter. The listing is identified by a unique code which the buyer uses to obtain further information about the property.

Retail shops may display unique codes to identify the items on display in a shop window. The prospective customer may be “window shopping” or does not have time to purchase the item or product. The present invention allows the customer to use the number to obtain more information about the item or product and either purchase the product online or visit the shop at a later more convenient time and make the purchase.

Live Event Organisers can use the System to allow Event Visitors to request information, brochures, and presentations from Exhibitors, Speakers and Sponsors. Reminders for Seminars can be requested.

System allows a user to wrap-up/personalize a response returned from an Identifier, so that they can easily share it with their friends electronically and be rewarded for it. The channels for this may be SMS, Email, Twitter, IM, Social Networks, etc. The shared response is traceable so that if any referees follow the shared response to get to the destination website, or to trigger an Identifier Response for them (perhaps to get an offer) then that action is traced back to the referrer and they are rewarded for the referral. The present invention may use a URL compression & ID tracking algorithm that will allow System track which System users shared which Identifiers Responses with which friends, on number of occasions. System can also track the number of recipients/referees that have followed a Response recommendation through to its destination. The identity of the referee & referrer is protected from the Identifier Owner, unless they elect to reveal themselves.

The computer programs according to the present invention may be developed by the skilled addressee.

The description is provided only by way of illustrative examples of the invention and that all modifications and variations are deemed to fall within the broad scope and ambit of the invention as described herein.

1. A method capable of auto responding to a user requesting information via a multiple channel medium in relation to goods and services wherein a response is transmitted via the same channel medium.

2. The method according to claim 1 wherein the identity of the user is not automatically disclosed to a third party.

3. The method according to claim 1 wherein the multi channel medium is selected from any one of Email, SMS, MMS, Twitter, Instant Message, Voice Recognition, locally installed iPhone, Android, Windows Mobile or Blackberry Applications, Photo, Bluetooth, Bar Code Reader, RFID/NFC, Mobile Web Page, GPS, Facebook or other Social Networking technologies.

4. The method according to claim 3 wherein the user may choose to disclose their chosen channel identity to a third party.

5. The method according to claim 3 wherein the identity of the provider or supplier of the goods and services is subscribed with a System.

6. The method according to claim 4 wherein the identity of the provider or supplier of the goods and services is displayed and/or identifiable via a unique name or number assigned to the provider or supplier.

7. The method according to claim 6 wherein the identity of the provider or supplier of goods and services is displayed at the physical business address.

8. A method capable of auto responding to a user requesting information via a multiple channel medium in relation to goods and services wherein a response is transmitted via the same or different channel medium.

9. A method capable of auto responding to a user requesting information via a multiple channel medium in relation to goods and services wherein a response is transmitted via the same or different channel medium, depending on the selection nominated by the user.

10. A computer program comprising machine-readable data obtained by auto responding to a user requesting information via a multiple channel medium in relation to goods and services wherein a response is transmitted via the same channel medium.

11. A computer program for storing and retrieving data comprising machine-readable data obtained by auto responding to a user requesting information via a multiple channel medium in relation to goods and services wherein a response is transmitted via the same channel medium.

12. A computer program comprising machine-readable data obtained by auto responding to a user requesting information via a multiple channel medium in relation to goods and services wherein a response is transmitted via the same or different channel medium, depending on the selection nominated by the user.

13. The method of claim any one of claims 8 and 9 wherein the user provides recommendations for a business and is duly rewarded.

14. The method of any one of claims 1 to 9 wherein the user requests information in relation to goods and services provided in a preferred location, and receives a response of listing of goods and services based on the request.

15. The method of claim 14 wherein the response includes promotional material.

16. The method of claim 14 wherein the promotional material includes vouchers.

17. The method according to any one of claim 8 or 9 wherein the response is transmitted via a different channel medium selected by the user.

18. The method according to claim 17 wherein the identity of the user is not disclosed to a third party.

19. The method according to any one of the preceding claims wherein the channel medium is selected from Twitter, MMS, Instant Message, Voice Recognition, locally installed iPhone, Android, Windows Mobile or Blackberry Applications, Photo, Bluetooth, Bar Code Reader, 2D Barcodes, GPS and Social Networks such as Facebook, LinkedIn, Ning, Xing and MySpace.

20. The method according to claim 18 or 19 wherein the goods and services are selected from the group consisting of restaurants, retail shops, real estate agents, advertisers and live event promoters.

21. The method as hereinbefore described according to the Examples.
